(19) United States
(12) Patent Application Publication
(10) Pub. No.: US 2011/0171047 A1
(43) Pub. Date: Jul. 14, 2011

(54) REMOVABLE LOCKING COUPLING FOR SHAFT

(75) Inventors: Larry J. Parmeter, Broken Arrow, OK (US); Joseph Scott Thompson, Owasso, OK (US); Josh S. Ledbetter, Tulsa, OK (US); Dan A. Merrill, Claremore, OK (US); David W. Chilcoat, Jenks, OK (US)

(73) Assignee: Baker Hughes Incorporated, Houston, TX (US)

(21) Appl. No.: 12/687,636

(22) Filed: Jan. 14, 2010

(51) Int. Cl. F04B 17/00; B23P 11/00

(52) U.S. Cl. 417/321; 29/525.02

(57) ABSTRACT

An electrical submersible pump has a pump assembly joined to a seal section. The pump assembly shaft, which may experience upthrust axial forces, may joined to the seal section shaft by a detachable coupling. The detachable coupling may have splines on its inner diameter that engage splines on the outer diameters of the pump assembly shaft and the seal section shaft. The detachable coupling can be bolted to one of the shafts. Locking members, such as plates, can be inserted through slots on the coupling to engage a recess on one of the shafts. A retaining device, such as a sleeve, can be used to hold the locking members in place.

### BACKGROUND OF THE INVENTION

1. Field of the Invention

The present invention relates to an apparatus and method for connecting a pump shaft to an adjacent shaft. More specifically, the invention relates to connecting the pump shaft of an electrical submersible pump to a motor shaft or seal section shaft such that upthrust forces from the pump are transferred to a thrust bearing in the seal section.

2. Description of the Related Art

Electrical submersible pumps (“ESP”) are used for pumping fluids from a wellbore. A typical ESP configuration includes an electric motor, a seal section, and a pump assembly. The pump assembly typically has a plurality of impellers connected to a shaft. A shaft from the motor rotates a shaft in the seal section, which in turn rotates the pump shaft and thus the pump impellers.

Two axial forces typically act on a pump impeller during operation—downthrust force and upthrust force. Downthrust force is defined as a force on the impellers acting against the direction of flow, thus urging impellers downward, toward the seal section (the upstream direction). Downthrust forces occur, for example, when head pressure exerts force on the impellers, thus urging the impellers in a direction opposite the direction of flow.

Upthrust force is defined as force acting on the impellers in the same direction as the direction of flow, thus urging impellers away from the seal section and toward the discharge tubing (the downstream direction). Upthrust forces occur, for example, when the discharge fluid from an impeller exerts axial force against the subsequent impeller.

Under normal operating conditions, downthrust force exceeds upthrust force, thus urging impellers in an upstream direction relative to flow (“downthrust condition”). In some circumstances, upthrust force may exceed downthrust force. This “upthrust condition” may occur during startup, before the pump develops head pressure, or during a maximum flow condition when there is little or no head pressure. Pump assemblies may not have adequate thrust bearings to support the pump shaft during upthrust conditions.

The seal section frequently has an upthrust bearing, which is a downward facing thrust bearing adapted to engage an upward facing thrust runner to support the seal section shaft in the upward axial direction. Many couplings between seal section shafts and pump assembly shafts, however, do not transfer upward axial force from the pump assembly to the seal section shaft. Indeed, the couplings must allow for axial insertion of at least one of the shafts when connecting the pump assembly or intake section to the seal section. It is desirable to have a device that allows for easy axial insertion of a shaft into a coupling that can be locked to prevent axial movement.

### SUMMARY OF THE INVENTION

A coupling is used to join a pump shaft to a seal section shaft for an electrical submersible pump (“ESP”). The seal section has a thrust bearing and a thrust runner connected to the seal section shaft, for transferring upthrust force from the seal section shaft to the thrust bearing. The coupling is used to transfer upthrust axial force from the pump shaft to the seal section shaft, and thus to the thrust bearing.

In one embodiment, the coupling is assembled by sliding the sleeve over the end of the coupling, then sliding a spring onto the coupling, and then installing a spring retainer to hold the spring in place. The coupling is then bolted to the seal section shaft. The pump intake and the pump assembly are connected to form a single unit. The pump intake and the seal section are brought together. As the intake and seal section are moved toward each other, the pump shaft moves axially into the coupling. Support plates, which protrude from the interior of the coupling into a recess in the pump shaft, are not yet installed, so the pump shaft is able to slide into the coupling. Bolts are used to join the housings of the seal section and the intake.

An operator can then reach through an access port, either by hand or with a tool, to retract the sleeve and thus expose a plurality of slots used for retaining plates. With the slots exposed, the operator can insert the retaining plates through the slots. The plates engage the edges of the slots and also engage a groove on the pump shaft. The operator then releases the sleeve to allow the spring to urge the sleeve toward a lip on the end of the coupling. The lip halts axial movement of the sleeve. With the sleeve now covering the slots, the plates are bounded in all directions—by the slots on four sides, by the groove, and by the sleeve. The plates thus lock the coupling to the pump shaft and prevent axial movement of the coupling relative to the pump shaft. The pump shaft has splines that engage splines on the interior of the coupling, and thus rotational movement is transferred from the coupling to the shaft. Similarly, a fastener prevents axial movement of the coupling relative to the seal section shaft, and splines on the coupling transfer rotation from splines on the seal section shaft to the coupling. The seal section shaft and the pump shaft thus move as a single unit in both the axial and rotational directions. Any upthrust axial forces acting on the pump shaft are transferred, to the plates, the coupling, the fastener, the seal section shaft, the thrust runner, the thrust bearing, and finally to the seal section housing.

To decouple the seal section shaft from the pump shaft, the operator retracts the sleeve and withdraws the plates. The seal section housing can then be removed from intake, and the pump shaft will slide out of the coupling in the axial direction.

### BRIEF DESCRIPTION OF THE DRAWINGS

So that the manner in which the above-recited features, aspects and advantages of the invention, as well as others that will become apparent, are attained and can be understood in detail, more particular description of the invention briefly summarized above may be had by reference to the embodiments thereof that are illustrated in the drawings that foau a part of this specification. It is to be noted, however, that the appended drawings illustrate only preferred embodiments of the invention and are, therefore, not to be considered limiting of the invention's scope, for the invention may admit to other equally effective embodiments.

FIG. 1 is a side view of an electrical submersible pump assembly constructed in accordance with the invention and in a wellbore.

FIG. 2 is a sectional view of the shaft interface of the pump shaft and seal section shaft of FIG. 1.

FIG. 3 is a partial sectional view of an alternative embodiment of the shaft interface and seal section of FIG. 1.

FIG. 4 is a sectional view of the locking ring of FIG. 3, taken along the 4-4 line.

### DETAILED DESCRIPTION OF THE EXEMPLARY EMBODIMENTS

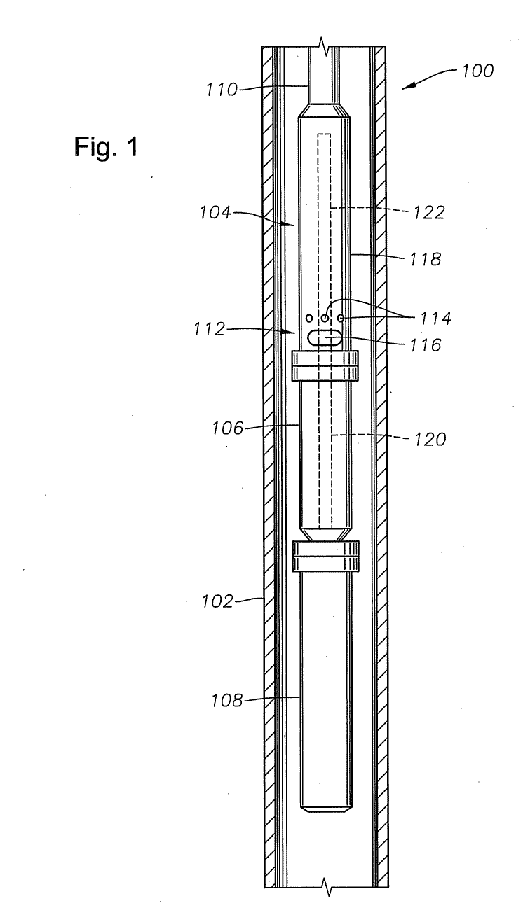

Referring to FIG. 1, electrical submersible pump (“ESP”) 100 is located in cased wellbore 102. ESP 100 includes pump assembly 104, seal section 106, and motor 108. ESP 100 may be suspended from tubing 110 in cased well 102, wherein it is submerged in wellbore fluid. Motor 108 may be any type of motor including, for example, an electric motor. Pump intake 112 is located at the lower end of pump 104. Wellbore fluid is drawn into pump intake 112 through apertures 114 that pass through the housing of pump intake 112. The wellbore fluid is then propelled by pump 104 through tubing 110 toward the surface of the earth. Wellbore fluid can include any fluid located in a wellbore including, for example, crude oil, water, gas, liquids, other downhole fluids, or fluids such as water that may be injected into a rock formation for secondary recovery operations.

For the sake of clarity in describing an embodiment of an ESP with a removable locking coupling, some references refer to “upper” and “lower,” as though ESP 100 is in a substantially vertical position. These positional references are for description only, and should not be construed to limit the invention to an application wherein electrical submersible pump 100 is in a vertical orientation. Indeed, ESP 100 may be in a horizontal orientation or any other orientation. Furthermore, the positional references are not intended to limit the claimed invention to the arrangement of the exemplary embodiment.

Seal section 106 has a housing 118, a seal section shaft 120, and device for equalizing pressure (not shown) of the lubricant in motor 108 with the hydrostatic fluid in well 102. Motor 108 has a shaft (not shown) that connects to seal section shaft 120. Seal section shaft 120 is a rotatable shaft that passes through seal section 106 to pump shaft 122. Pump assembly 104 includes impellers (not shown) that are rotated by pump shaft 122, which is a rotatable shaft, and diffusers (not shown) that are stationarily located within pump housing 118.

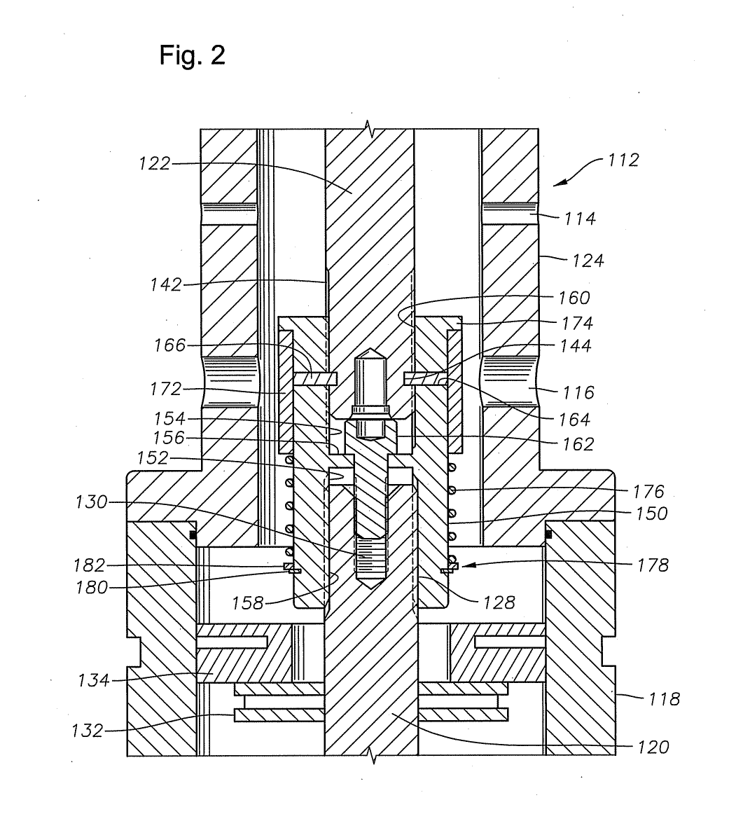

Referring to FIG. 2, pump intake 112 is a cylindrical member having housing 124 and a central bore passing therethrough. Pump intake 112 may be an integral part of pump assembly 104 (FIG. 1), wherein housing 124 is also the housing of pump assembly 104, or pump intake 112 may be a detachable member connected to pump assembly 104. Apertures 114 pass through housing 124 for wellbore fluids to enter pump intake 112 and then move through the bore of pump intake 112 to pump assembly 104.

One or more coupling access ports 116 are located on the circumference of housing 124. Coupling access ports 116 are apertures for accessing members located within pump intake 112. Indeed, access ports 116 may be large enough for a person's hand or a tool such as pliers (not shown) or a spanner wrench (not shown) to reach through housing 124 for manipulating members located within housing 124. During normal operation of ESP 100, wellbore fluids may pass through coupling access ports 116 into the bore of pump intake 112. Because wellbore fluids normally pass into pump intake 112, there may be no need to cover coupling access ports 116, although a cover (not shown) may be used. In some embodiments, apertures 114 and coupling access ports 116 are one in the same, wherein wellbore fluids are drawn through coupling access port 116 and additional apertures 114 are not required.

Still referring to FIG. 2, seal section shaft 120 is rotated by motor 108 (FIG. 1) and is concentric within seal section housing 118. Splines 128 may extend axially along the outer diameter of a portion of seal section shaft 120 near one or both ends. Thus an end having splines 128 is a splined end. Splines 128 provide radial shoulders for transferring torque from or to adjacent rotating members. Fastener receptacle 130 may be located in the end face of one or both ends of seal section shaft 120. In some embodiments, fastener receptacle 130 is a threaded bore that is concentrically located in the end of seal section shaft 120.

Thrust runner 132, which can be conventional, may be located on the outer diameter of seal section shaft 120. Thrust runner 132 may be an annular ring or plate affixed to seal section shaft 120 by a variety of common techniques. Thrust bearing 134 may be fixedly connected to seal section housing 118 above thrust runner 132. Thrust bearing 134 is conventional and may be used to provide axial support to seal section shaft 120, via thrust runner 132, while, seal section shaft 120 is rotating relative to seal section housing 118. Thus, thrust bearing 134 prevents upward axial movement of seal section shaft 120.

Pump shaft 122 is connected to impellers (not shown) inside pump assembly 104. Splines 142 are located on the seal section end of pump shaft 122, thus establishing a splined end, and splines 142 are used to transfer torque to pump shaft 122. Groove 144 is a recess. In one embodiment, groove 144 may be an annular recess located on the outer diameter of pump shaft 122. In a preferred embodiment, the sidewalls of groove 144 are generally perpendicular to the axis of pump shaft 122 and the bottom of groove 144 is generally parallel to the axis pump shaft 122. Alternatively, groove 144 may be a plurality of individual notches, recesses, or bores (not shown) space apart around the outer diameter of pump shaft 122.

Coupling 150 is a cylinder for transferring torque from seal section shaft 120 to pump shaft 122. The inner diameter of coupling 150 includes two sections, lower bore 152 and upper bore 154, each separated by shoulder 156. The inner diameter of lower bore 152 is generally the same as the outer diameter of seal section shaft 120. Lower splines 158 are internal splines located on the inner diameter of lower bore 152 and are adapted to engage splines 128 of seal section shaft 120. Similarly, the inner diameter of upper bore 154 is generally the same as the outer diameter of pump shaft 122. Upper splines 160 are internal splines located on the inner diameter of upper bore 154, and are adapted to engage splines 142 of pump shaft 122.

Shoulder 156 protrudes inwardly from the bore of coupling 150. In a preferred embodiment, shoulder 156 is a rib having at least one flat surface facing downward, toward lower bore 152. Fastener 162, which may be a threaded fastener, such as a bolt, can pass through the cylindrical opening formed by shoulder 156. Other fastener configurations can be used to detachably or permanently connect coupling 150 to one of seal section shaft 120 or pump shaft 122. For example, horizontal threaded fasteners (not shown) may pass through the sidewall of coupling 150 into the sidewall of seal section shaft 120, wherein the fasteners are perpendicular to the axis of shaft 120. In alternative embodiments, coupling 150 may be welded (not shown) to shaft 120, or may be machined as an integral member (not shown) of shaft 120.

Slots 164 are a plurality of apertures through the sidewall of coupling 150. In a preferred embodiment, slots 164 are a pair generally rectangular openings passing from the exterior of coupling 150 to the upper bore 154 region of the interior of coupling 150. Regardless of the number of slots 164, slots 164 may be equilaterally spaced apart from one another. Keys 166 are rigid elements that are sized to pass through slots 164 to engage groove 144 of pump shaft 122 and thus function as an axial locking member. Keys 166 may be, for example, steel plates having a rectangular profile. The length of keys 166 may be roughly equal to the sum of the thickness of the sidewall of coupling 150 at slot 164 plus the depth of groove 144. Thus, keys 166 fit flush in slot 164 when inserted through slot 164 to engage groove 144. Keys 166 and slots 164 may have alternative shapes. For example, keys 166 may have a round profile (not shown), and slots 164 may have a similar round profile. Keys 166 are spaced apart from each other around the circumference of coupling 150.

Other embodiments may have an axial locking member that includes, for example, pins, dowels, or plates, any of which may be pass through slots 164 to engage a feature on pump shaft 122. For example, in one alternative embodiment, pump shaft 122 may have a horizontal bore (not shown) that is perpendicular to the axis of pump shaft 122. A pin (not shown) may pass through round slots (not shown) in the sidewall of coupling 150 to engage coupling 150 and pump shaft 122.

Retainer sleeve 172 is a cylinder adapted to slidingly engage the outer diameter of coupling 150. Sleeve 172 has an upper or retaining position that encloses the outer ends of keys 166 to retain them in engagement with groove 144. Sleeve 172 has a lower or released position that is spaced below slots 164 to insert or withdraw keys 166. The axial length of sleeve 172 is preferably less than the axial length of coupling 150. Lip 174 protrudes from the outer diameter of one end of coupling 150 to stop sleeve 172 from moving axially past the end of coupling 172.

Spring 176 is concentrically located on the outer diameter of coupling 150. Spring 176 urges sleeve 172 to the retaining position in engagement with lip 174. Spring retainer 178 supports one end of spring 176 and thus prevents spring 176 from extending past the end of coupling 150. Spring retainer 178 may include snap-ring 180 located in a groove on the outer diameter of coupling 150. Spring retainer 178 may also include support surface 182 for engaging spring 176 and transferring force from spring 176 to snap-ring 180. Support surface 182 may be, for example, an annular ring such as a washer. In alternative embodiments, spring retainer 178 may use different types of members for supporting spring 176 such as, for example, pins (not shown), threads (not shown), or a flange (not shown). In one embodiment (not shown), spring retainer 178 is located at the sleeve end of coupling 150 to prevent sleeve 172 from moving past the end of coupling 150, and lip 174 is located on spring end of coupling 150 to retain spring 176.

In operation of one embodiment, coupling 150 is assembled by sliding sleeve 172 over the end of coupling 150, then sliding spring 176 onto coupling 150, and then installing spring retainer 178. Coupling 150 is then bolted to seal section shaft 120 with fastener 162. Intake 112 and pump assembly 104 are then connected to each other. As intake 112 and seal section 106 are moved toward each other, pump shaft 122 moves axially into coupling 150. Keys 166 are not yet installed, so pump shaft 122 is able to slide into coupling 150. Bolts are used to join the housings of seal section 106 and intake 112.

An operator can then reach through access port 116, either by hand or with a tool, to retract sleeve 172 to the released position and thus expose slots 164. With slots 164 exposed, the operator can insert keys 166 through slots 164. The keys engage the edges of slots 164 and also engage groove 144. The operator then releases sleeve 172, thus allowing spring 176 to urge sleeve 172 toward lip 174. Lip 174 halts axial movement of sleeve 172. With sleeve 172 now covering slots 164, keys 166 are bounded in all directions—by slots 164 on four sides, by groove 144, and by sleeve 172. Keys 166 thus lock coupling 150 to pump shaft 122 and prevents axial movement of coupling 150 relative to pump shaft 122. Pump shaft splines 142 engage coupling splines 160, and thus rotational movement is transferred from coupling 150 to shaft 122. Similarly, fastener 162 prevents axial movement of coupling 150 relative to seal section shaft 120, and splines 158 transfer rotation from seal section shaft 120 to coupling 150. Seal section shaft 120 and pump shaft 122, thus, move as a single unit in both the axial and rotational directions. Upthrust axial forces acting on pump shaft 122 are transferred to keys 166, coupling 150, fastener 162, seal section shaft 120, thrust runner 132, thrust bearing 134, and finally to seal section housing 118. As wellbore fluid is drawn in through coupling access port 116, the wellbore fluid may flow past and contact sleeve 172. The retaining position of sleeve 172 may be in the downstream direction, and thus the force exerted on sleeve 172 by the fluid can urge sleeve 172 toward the retaining position.

To decouple the seal section shaft 120 from the pump shaft 122, the operator retracts sleeve 172 and withdraws keys 166. Seal section housing 118 can then be removed from intake 112, and pump shaft 122 will slide out of coupling 150 in the axial direction.

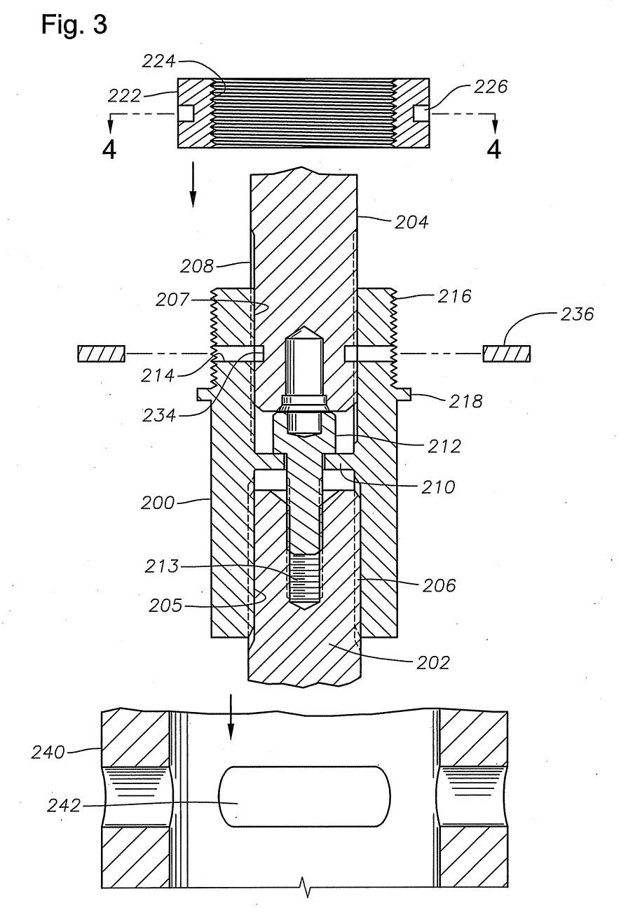

Referring to FIG. 3, in an alternative embodiment, threaded coupling 200 may be used to connect seal section shaft 202 to pump shaft 204. Threaded coupling 200 is a cylinder having a bore. Splines 205 on the inner diameter of coupling 200 engage splines 206 on the outer diameter of seal section shaft 202 to transfer torque from seal section shaft 202 to coupling 200. Similarly, splines 207 on the inner diameter of coupling 200 engage splines 208 on the outer diameter of pump shaft 204 to transfer torque from coupling 200 to pump shaft 204.

Shoulder 210 protrudes from the bore, and may be used to engage seal section shaft 202. The downward facing surface of shoulder 210 is supported by seal section shaft 202. Bolt 212 passes through shoulder 210 to engage a threaded receptacle 206 on seal section shaft 202.

Slots 214 are apertures passing through the sidewall of threaded coupling 200. Slots 214 may be rectangular, square, round, or any other shape. Threads 216 are located on the outer circumference of threaded coupling 200. Threads 216 may be located in the vicinity of slots 214, or may be above or below slots 214. Collar stop 218 is a shoulder that may protrude beyond an outer diameter of threaded coupling 200.

In this embodiment, threaded collar 222 may be a retainer sleeve. Threaded collar 222 is an annular ring having threads 224 located on its inner diameter. Threads 224 threadingly engage threads 216 of collar shaft. When collar 222 is threadingly engaged with coupling 200, collar 222 can cover all or a portion of slots 214 on coupling 200. In some embodiments, collar 222 can be tightened on coupling 200 until an end of collar 222 engages collar stop 218, thus preventing further rotation of collar 222.

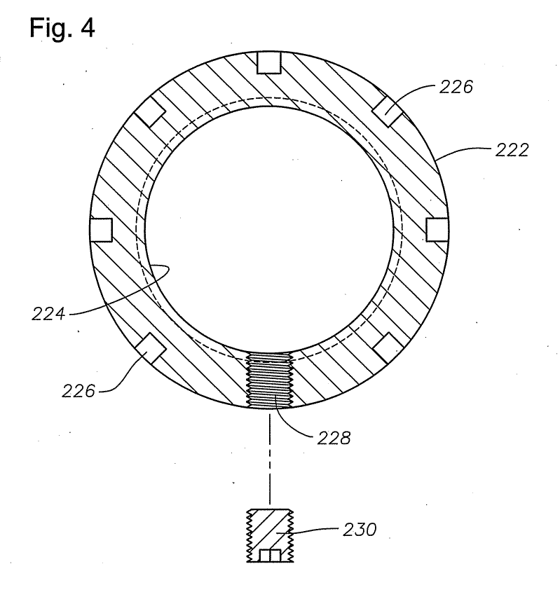

As shown in FIG. 4, a plurality of sockets 226 may be located around the circumference of collar 222. Sockets 226 may be a cylindrical bore all the way through the sidewall of collar 222, or partially sunk into the sidewall of collar 222. Sockets 226 may be adapted to receive a round pin from a pin wrench (not shown) to facilitate rotating collar 222 with the pin wrench. Alternatively, sockets 226 could be, for example, vertical grooves (not shown) adapted to engage the teeth of a spanner wrench (not shown).

One or more set-screw bores 228 may pass through the sidewall of collar 222, perpendicularly to the axis of collar 222. Each set-screw bore 228 may be used to engage set screw 230, set screw 230 being a threaded bolt or screw. In some embodiments, set screw 230 is an “allen-head” screw. In some embodiments, set screw 230 does not have a shoulder at its head and thus may be sunk flush with the outer diameter of collar 222. After collar 222 is threadingly engaged to coupling 200, set screws 230 may threadingly engage threaded bore 228 and an end of set screw 230 may engage an outer diameter surface of coupling 200, thereby preventing collar 222 from rotating relative to collar 200.

Pump shaft 204 may have groove 234 on its outer diameter. Groove 234 may be a single groove around the circumference of pump shaft 204, or may be a plurality of slots or notches spaced apart around the circumference of pump shaft 204. Keys 236 may pass through slots 214 of coupling 200, and engage groove 234 of pump shaft 204.

In operation, coupling 200 is bolted to seal section shaft 202 using bolt 212 to engage shoulder 210 and threaded receptacle 206. Thus, splines 205 of coupling 200 engage splines 206 of seal section shaft. Preferably, collar 222 is placed on coupling 200 before coupling 200 is connected to pump shaft 204. As seal section housing (not shown) is connected to intake housing 240, coupling 200 engages pump shaft 204 (and thus splines 207 of coupling 200 engage splines 208 of pump shaft 204).

Collar 222 is then rotated, if necessary, to expose slots 214. Keys 236 are inserted into slots 214 until keys 236 engage groove 234 on pump shaft 204. Collar 222 is then tightened on threads 216. In embodiments having collar stop 218, collar 222 may be tightened against collar stop 218. A tool (not shown) may be used to engage sockets 226 to tighten collar 222 to a predetermined torque. Collar 222 now covers slots 214 and thus prevents keys 236 from disengaging groove 234 or slots 214. Set screws 230 may be tightened into bores 228 to prevent collar 222 from rotating relative to coupling 200. In one embodiment, oval shaped access ports 242 are openings in the sidewall of intake 240. Access ports 242 allow sufficient clearance to access coupling 200 for inserting keys 236 and to rotate collar 222 with a tool (not shown).

While the invention has been shown or described in only some of its forms, it should be apparent to those skilled in the art that it is not so limited, but is susceptible to various changes without departing from the scope of the invention.

What is claimed is:

1. An apparatus for pumping fluids from or into a wellbore, the apparatus comprising:
a housing assembly comprising a first housing and a second housing;
a rotatable first shaft substantially located in the first housing, the first shaft having a splined end;
a rotatable second shaft substantially located in the second housing, the second shaft having a splined end and an external recess;
a coupling having internal splines that engage the splined ends of the first and second shafts to transfer torque, the coupling being secured to the first shaft, the coupling having a cylindrical sidewall containing an aperture;
an axial locking member extending through the aperture in a radial direction relative to a longitudinal axis of the housing assembly and into engagement with the recess to axially lock the first and second shafts together; and
a retainer sleeve that fits on the exterior of the coupling and is movable axially relative to the coupling from a released position, which allows the axial locking member to be inserted and withdrawn from the aperture, to a retaining position, blocking the axial locking member from moving inward and outward from the aperture.

2. The apparatus of claim 1, wherein the recess comprises an annular groove extending around a circumference of the second shaft.

3. The apparatus of claim 1, wherein the axial locking member is a key.

4. The apparatus of claim 1, wherein a threaded fastener connects the coupling to the first shaft.

5. The apparatus of claim 1, the apparatus further comprising a spring, wherein the spring urges the retainer sleeve into the retaining position.

6. The apparatus of claim 5, wherein the spring comprises a coiled spring, the coiled spring encircling the coupling.

7. The apparatus of claim 2, wherein the annular groove extends through the splines of the splined end of the second shaft.

8. The apparatus of claim 1, wherein the retainer sleeve has threads on an inner diameter that engage threads on an exterior of the coupling to secure the retaining sleeve in the retaining position.

9. The apparatus of claim 1, further comprising an aperture through a sidewall of the housing assembly, the aperture adapted to provide access to the coupling when the first housing is connected to the second housing.

10. A method for connecting a rotatable first shaft to a rotatable second shaft, the method comprising:
(a) axially inserting a splined end of the first shaft into a first end of a coupling, the coupling having internal splines;
(b) axially inserting a splined end of the second, shaft into a second end of the coupling, the splined end of the second shaft having an external recess;
(c) creating a housing assembly by connecting a first housing section and a second housing section, wherein the coupling is located within the housing assembly;
(d) inserting an axial locking member through an aperture located on the coupling, the axial locking member being inserted in a radial direction relative to a longitudinal axis of the housing assembly, the axial locking member being adapted to engage the recess on the splined end of the second shaft and further adapted to engage at least one edge of the aperture to prevent axial movement of the second shaft relative to the coupling cylinder; and
(e) moving a retainer sleeve axially along the outer diameter of the coupling from a released position, which allows the axial locking member to be inserted and withdrawn from the aperture, to a retaining position, which blocks the axial locking member from moving inward and outward from the aperture.

11. The method according to claim 10, wherein step (d) comprises accessing the coupling through an aperture, the aperture passing through a sidewall of the housing assembly.

12. The method according to claim 10, wherein step (e) comprises using a spring to urge the retainer sleeve toward the retaining position.

13. The method according to claim 10, wherein the retainer sleeve threadingly engages the coupling, and wherein step (e) comprises rotating the retainer sleeve relative to the coupling to move the retainer from the released position to the retaining position.

14. The method according to claim 10, wherein step (a) comprises attaching the coupling to the first shaft with a threaded fastener.

15. The method according to claim 10, further comprising:
(f) attaching a thrust bearing to the housing assembly and attaching a thrust runner to one of the first shaft or the second shaft,
(g) creating an axial force on the second shaft, wherein the axial force acts in a direction away from the first shaft, and
(h) transferring the axial force from the second shaft, through the coupling, first shaft, and thrust runner, to the thrust bearing.

16. The method according to claim 10, further comprising drawing wellbore fluid through the assembly, wherein the direction of flow urges the retainer toward the retaining position.

17. An apparatus for pumping fluid to or from a wellbore, the apparatus comprising:
a motor assembly;
a seal section having a seal section housing and a seal section shaft, the seal section shaft adapted to be rotated by the motor assembly;
a pump assembly having a pump assembly housing and a pump assembly shaft, the pump assembly housing being detachably connected to the seal section housing;
a cylindrical coupling connected to the seal section shaft, the cylindrical coupling comprising:
a plurality of splines located on an inner diameter surface;
a plurality of apertures extending through a sidewall of the coupling for receiving a plurality of locking members;
a sleeve having a released position and a retaining position, wherein the sleeve covers the apertures in the retaining position;
a spring mounted to the coupling and biasing the sleeve toward the retaining position;
wherein the plurality of splines on the cylindrical coupling engage a plurality of splines located on the outer diameter of the seal section shaft and a plurality of splines on the outer diameter of the pump assembly shaft;
wherein the plurality of locking members are insertable through the apertures into engagement with a groove, the groove being located on at least one of the seal section shaft or the pump assembly shaft, while the sleeve is in the released position, and the sleeve blocks movement of the locking members from the apertures while in the retaining position.

18. The apparatus of claim 17, wherein the sleeve is adapted to be urged toward the retaining position when wellbore fluid is drawn through the pump assembly.

19. The apparatus of claim 17, wherein the groove comprises an annular groove extending around a circumference of the pump assembly shaft.

20. The apparatus of claim 17, wherein the locking members comprise keys.
